(19) United States
(12) Patent Application Publication
(10) Pub. No.: US 2025/0251978 A1
(43) Pub. Date: Aug. 7, 2025

(54) METHOD AND SYSTEM FOR DETERMINING AND USING PROFILE CHARACTERISTICS IN A HETEROGENEOUS ENVIRONMENT

(71) Applicant: Telefonaktiebolaget LM Ericsson (publ), Stockholm (SE)

(72) Inventors: Ganapathy Raman Madanagopal, Bengaluru (IN); Chakri Padala, Bangalore (IN); Anubhav Guleria, New Delhi Delhi (IN)

(21) Appl. No.: 18/856,154

(22) PCT Filed: Apr. 11, 2022
(86) PCT No.: PCT/IN2022/050349

§ 371 Date: Oct. 11, 2024

(51) Int. Cl. G06F 9/50; G06F 11/30

(52) U.S. Cl. CPC G06F 9/5016; G06F 11/3037

(57) ABSTRACT

A method and computing system for determining memory profile and determining suitable memory type for allocation to memory type are disclosed. The method comprises monitoring a memory usage for each one of a plurality of memory pages associated with an application. The method comprises determining a memory profile for the application based on the monitoring, the memory profile comprising memory usage pattern information for each one of the plurality of memory pages associated with the application.

### TECHNICAL FIELD

Disclosed are embodiments related to the use of applications in heterogeneous computing environment, and more particularly related to the allocation of applications in computing environment deploying heterogeneous memories.

### BACKGROUND

With the development of the multi-core and multi-threading technology, Dynamic Random-Access Memory (DRAM) can no longer meet the growing memory demands of applications due to restrictions in terms of power consumption and overheads such as read and write speeds, refresh cycles, etc. Further, DRAM capacity and bandwidth are constrained by silicon process technologies.

As a result, integrating diverse memories into a cloud/edge and sharing resources among them is very desirable. In such scenarios, heterogeneous computing environment formed by heterogeneous memories in a distributed manner is beneficial for executing complex applications requiring large amounts of computational power. In the heterogeneous computing environment, the applications can take advantage of the diverse memories. Heterogeneity is typically desired in distributed systems. Memory sharing between diverse memories will be conceivable with such a heterogeneous computing environment.

A heterogeneous computing environment could be formed by a combination of volatile and non-volatile memories. Typically, non-volatile memories have varied physical characteristics when compared with DRAM. Emerging Non-Volatile Memories (NVMs), such as persistent memories (PMEM) or High Bandwidth Memory (HBM) have comparable read speed with DRAM and different scalability characteristics. While PMEM write speed is comparatively slower than that of DRAM, PMEM is generally available in larger capacities in comparison to DRAM for the same cost (PMEM costs less per gigabytes (GB) currently). Similarly, on-chip HBM can provide large memory bandwidth and lower latencies in comparison to DRAM but has higher cost per GB. Thus, a mainstream approach at present is to integrate a variety of new memory technologies with DRAM technologies to form a heterogeneous memory system, so that the performance, power efficiency, scalability, bandwidth and endurance of the memory system are improved by exploiting the new memory technologies. However, as the characteristics and quantities of these heterogeneous memories could differ across servers, it is difficult for developers to optimize their application for memory page allocation across different heterogeneous memories.

Existing memory page allocation techniques allocate memory to DRAM (by default) when an application requests for memory. While simple considerations like NUMA affinity (Affinity for an application towards a specific memory node in a Non-Uniform Memory Access environment), group limits or the allocation policies like local-first, round-robin, interleaving and the like are used for allocating the memory, other considerations such as application characteristics, usage/access patterns, types of heterogeneous memories available, etc. are not considered while allocating the physical memory pages. As a result, current allocation techniques can lead to performance degradation and under-utilization of some heterogeneous memories on the servers.

Another existing technique uses a reactive approach to monitor the application's memory accesses and dynamically moves the memory pages between the DRAM and other heterogeneous memories at runtime. In the reactive approach, new page requests are allocated in DRAM or any other available memory. Later, after monitoring the performance of the application, corresponding memory pages are migrated to a more suitable memory. The aforesaid technique migrate and place the memory pages in suitable memories at runtime. However, since the approach is reactive, the applications performance would be degraded until the pages are moved to suitable memories. For example, pages classified as cold or not so write-intensive residing in PMEM must be moved to DRAM when the respective pages become hot or write-intensive. The time incurred in identifying and classifying the pages (classifying as hot, cold and the like) and the time required for migrating the pages to new memory and associated page table setups can slow down the application performance. Typically, these existing techniques use short-term temporal memory access patterns to classify pages and move them between the memories. As the number of active memory pages changes, the resources needed for classification and relocation of these pages increases, the resource utilization of monitoring frameworks increases, thus degrading the application performance.

In another related technique, memory allocations with specific memory system are classified as suitable for the corresponding memory request via an application programming interface (API) or as hints in the code. During runtime, the memory allocation follows the hints mentioned in the code. However, the aforesaid approach is suitable only if the deployed memories are known to a user ahead of time, which is difficult in a cloud environment as well as across different cloud environments. Further, the approach is unsuitable for more extensive data structures and data sets where it is challenging to perform individual classifications in advance.

Some of the terminologies used in this disclosure are explained below:

Dynamic Random-Access Memory (DRAM) refers to a type of semiconductor memory that is typically used for the data or program code needed by a computer processor to function. DRAM is a common type of random access memory (RAM) that is used in personal computers (PCs), workstations, and servers.

Persistent Memory is a non-volatile, byte addressable, low latency memory with densities greater than or equal to Dynamic Random-Access Memory (DRAM).

High-Bandwidth Memory (HBM) refers to a high-speed computer memory and is a standardized stacked memory technology that provides very wide channels for data, both within the stack and between the memory and logic.

Hot page—The concept of hot and cold pages is introduced in the buddy system of the Linux kernel physical memory management. The hot page refers to a memory page which has been accessed recently, where the memory page has data therein and is allocated to an application.

Cold page—A cold page indicates that a memory page has not been accessed for a period of time, where the period of time could be microseconds, milliseconds, or seconds.

Non-uniform memory access (N UMA) refers to a computer memory design used in multiprocessing, where the memory access time depends on the memory location relative to the processor.

Address space layout randomization (ASLR)—ASLR is a memory-protection process for operating systems (OSes) that guards against buffer-overflow attacks by randomizing the location where system executables are loaded into memory. ASLR is able to put address space targets in unpredictable locations.

Randomized virtual address: Refers to the virtual address range allocated at random memory location due to ASLR. For security reasons, these addresses get assigned (randomly) to a different memory address on subsequent runs.

Normalized Address: Refers to a common identifier or key that could be used to associate address across the runs of the application. Normalized address is the difference/offset from the starting location of memory address to a particular memory address.

### SUMMARY

Existing solutions for memory allocation in heterogeneous environment do not consider processing environment metrics such as cloud requirements, priority of an application, Service Level Agreements (SLA) associated with the application, current memory utilization, availability of memories and types of heterogeneous memories. Furthermore, there does not exist a system that considers memory profile and additional factors such as application's priority, requirements and constraints from execution environment/cloud operator, application's efficiency in utilizing the allocated pages, and the like for determining suitable memory for allocation.

Accordingly, there is a need for methods and systems that can allocate memory pages in suitable memory after considering an applications memory profile (memory profile comprises memory characteristics and access patterns from initial test runs). Hence, it is desirable to design methods and systems that can determine the memory profile associated with the application and use the memory profile along with requirements and constraints associated with the processing environment to allocate memory pages.

Accordingly, in one aspect, there is provided a method performed by a computing system. The method comprises monitoring a memory usage for each one of a plurality of memory pages associated with an application. The method comprises determining a memory profile for the application based on the monitoring, the memory profile comprising memory usage pattern information for each one of the plurality of memory pages associated with the application.

In another aspect, there is provided a method performed by a computing system. The method comprises obtaining a memory profile corresponding to an application. Thereafter, the method comprises determining at least one suitable memory type for allocation to at least one memory page associated with the application based on the memory profile obtained. The method comprises allocating the at least one memory page to the determined memory type.

In another aspect, there is provided a computing system. The computing system is configured to monitor a memory usage for each one of a plurality of memory pages associated with an application. The computing system is configured to determine a memory profile for the application based on the monitoring, the memory profile comprising memory usage pattern information for each one of the plurality of memory pages associated with the application.

In another aspect, there is provided a computing system configured to obtain a memory profile corresponding to an application. The computing system is configured to determine at least one suitable memory type for allocation to at least one memory page associated with the application based on the memory profile obtained. The computing system is configured to allocate the at least one memory page to the determined memory type.

Methods and/or systems according to embodiments of this disclosure may provide one or more of the following advantages:

Allocating memory pages onto an appropriate memory when the application requests for memory would help in avoiding the migration of a large number of pages between the memories during the runtime and thus helps in maintaining application performance. Avoiding or at least reducing migration of pages would also contribute to reducing additional resource consumption (CPU, energy and the like).

Proactive allocation of memory pages to the most appropriate memory (allocating memory pages onto an appropriate memory in the heterogeneous environment when the application requests for memory) may provide low memory access delay, low write power consumption, and high endurance of the DRAM

### BRIEF DESCRIPTION OF THE DRAWINGS

The accompanying drawings, which are incorporated herein and form part of the specification, illustrate various embodiments.

FIG. 1 shows a system according to some embodiments.

FIG. 2a shows an exemplary implementation of a profiler module, according to some embodiments.

FIG. 2b shows a use-case example according to some embodiments.

FIG. 3a shows a system according to some embodiments.

FIG. 3b shows an exemplary implementation of the memory recommender module, according to some embodiments

FIG. 4 shows a process according to some embodiments.

FIG. 5 shows a process according to some embodiments.

FIG. 6 is a block diagram of an apparatus according to some embodiments

### DETAILED DESCRIPTION

Certain aspects of the present disclosure and their embodiments may provide solutions to the challenges discussed above. There are, proposed herein, various embodiments which address one or more of the issues disclosed herein.

Typically, heterogeneous memories may include a combination of volatile and Non-Volatile Memories (NVMs), such as Dynamic Random-Access Memory (DRAM), Persistent Memories (PMEM). High Bandwidth Memory (HBM), and the like. An heterogeneous computing environment is formed by a combination of such heterogeneous memories with one or more Central Processing Units (CPUs), input-Output devices configured to receive an application, and/or a server coupled thereto. Each memory from a plurality of memories present in the heterogeneous memory is usually suited for specific types of memory accesses (memory accesses in response to application request). Existing solutions for memory allocation in heterogeneous environment do not consider applications memory characteristics and access patterns from previous runs, processing environment metrics (such as cloud requirements), priority of an application, Service Level Agreements (SLA) associated with the application, availability of free memories and types of heterogeneous memories. Thus, it is desirable to have a method and system to determine memory profile (memory profile includes memory usage pattern information of applications, with their normalized addresses and corresponding page characteristics) to further determine the most suitable memory or memories for allocation. Further, it is also desirable to have a method and system that uses memory profile along with requirements (e.g., SLA requirements, priority of application, etc.) and constraints associated with a processing environment (such as server requirements) to allocate memory to application.

The embodiments described herein present a method and a related system to determine the memory profile. The method comprises monitoring a memory usage for each one of a plurality of memory pages associated with an application. The method comprises determining a memory profile for the application based on the monitoring, the memory profile comprising memory usage pattern information for each one of the plurality of memory pages associated with the application.

The embodiments herein also present a method and a related system to determine at least one suitable memory type for allocation from the plurality of memories in the heterogeneous environment to at least one memory page associated with the application based on the memory profile obtained. The method comprises obtaining a memory profile corresponding to the application. Thereafter, the method comprises determining at least one suitable memory type for allocation to at least one memory page associated with the application based on the memory profile obtained.

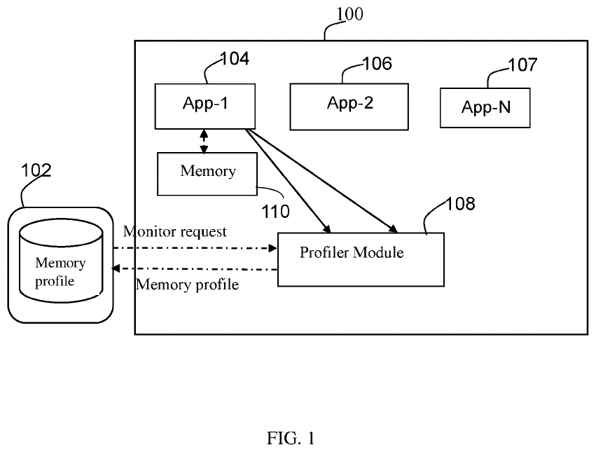

FIG. 1 shows a system 100 according to some embodiments. The system 100 is a computing system in an embodiment. The system 100 may include a profiler module 108, a heterogeneous memory 110 and a plurality of applications 104, 106, 107 (App-1, App-2, . . . , App-N). Additionally, the system 100 may be communicatively coupled to a controller 102. In an example, the controller 102 may be implemented in a cloud server. The controller 102 is configured to transmit a monitoring request for determining memory profile of an application from the plurality of applications 104, 106, 107 to the profiler module 108. The profiler module 108 and the heterogeneous memory 110 may be implemented in a computing system, or in a single physical entity, or a network node, or distributed in a local network or in a cloud to form system 100. Herein, the heterogeneous memory 110 formed by a combination of volatile and non-volatile memories, for example, a combination of DRAM, Persistent Memories (PMEM), High Bandwidth Memory (HBM), Remote Memory, and the like.

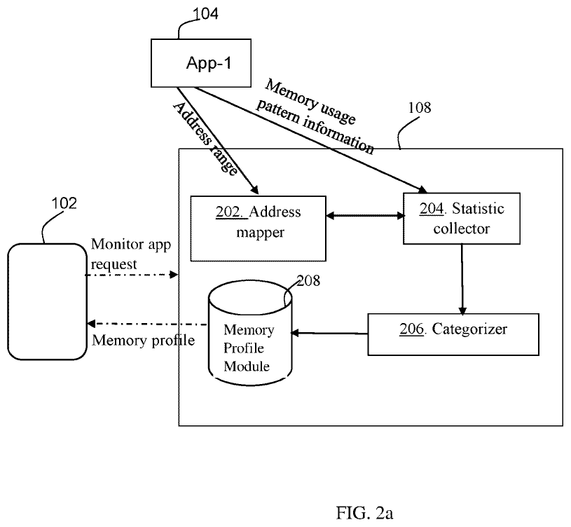

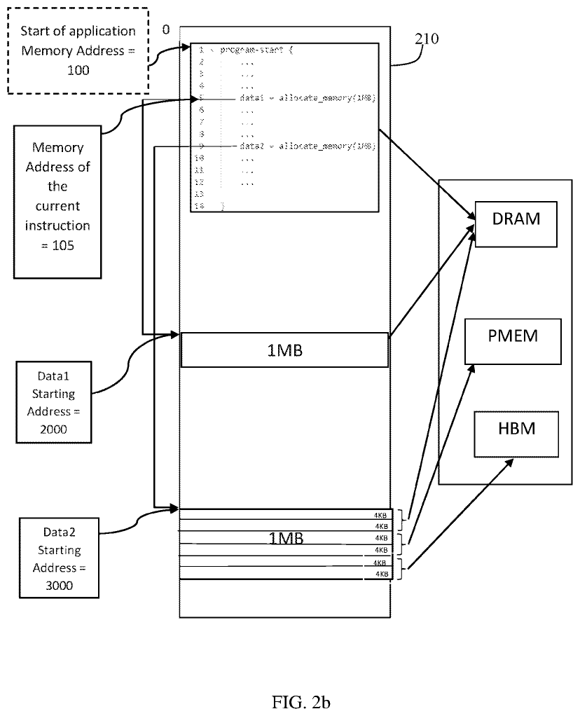

The profiler module 108 is configured to receive the monitoring request from the controller 102. In an example, the monitoring request corresponds to determining a memory profile for the App-1 (104) from the plurality of applications during an initial test run of App-1. In response to the monitoring request, the profiler module 108 is configured to monitor the App-1 to record memory usage pattern information and thereby determine its memory profile. The profiler module 108 is configured to obtain a set of randomized virtual addresses of pages used by various parts of the application. The randomized virtual addresses vary during each run because of the Address Space Layout Randomization (ASLR) security feature employed by operating systems to prevent security attacks, especially in cloud environments. Hence, the profiler module 108 is configured to determine a set of normalized addresses from the set of the randomized virtual addresses. The normalized address provides a standard identifier that may be used across multiple runs of App-1. The normalized address is determined by calculating a difference/offset value from a starting location of an application code (of App-1) to an instruction (or function) in the application code requesting a memory page (A page, memory page, or virtual page, is a fixed-length contiguous block of virtual memory, described by a single entry in the page table). The determination of the normalized address will be further elaborated in FIG. 2.

Referring back to FIG. 1, the profiler module 108 is further configured to map the memory usage pattern information with each normalized address determined. The memory usage pattern information for each one of the plurality of memory pages associated with the application may comprise a write intensity indication, a read intensity indication, an access frequency indication, and an access bandwidth indication. In an example, the write intensity indication, read intensity indication, an access frequency indication, and an access bandwidth indication could be represented by one of a label, a numerical value, or a range of values. Based on the memory usage pattern information, each normalized address is categorized with a page characteristic, such as frequently accessed page, cold page, hot page, read-only page, write-only page, and the like. In addition, the page characteristics could include other information or metrics corresponding to the randomized virtual address. After that, the profiler module 108 is configured to transmit the memory profile containing the memory usage pattern information, the set of normalized addresses, and corresponding page characteristics to the controller 102.

FIG. 2a shows an exemplary implementation of a profiler module 108, according to some embodiments. The profiler module 108 comprises an address mapper 202, a statistic collector 204, a categorizer 206, and a memory profile module 208. The address mapper 202 is configured to obtain the set of randomized virtual addresses of pages used by various parts of the application. Each part of the application is mapped to a virtual address, hereafter referred to as the randomized virtual address. Typically, when an application code is executed, each part of the application code such as global data, code, stack, heap and the like, are mapped to specific virtual memory address ranges. In an exemplary embodiment, the randomized virtual addresses can be obtained using a ‘/proc’ interface (Proc is a file system in Linux Operating System that is used to obtain information about data structures relating to a process/application). The address mapper 202 is configured to identify a starting address of the application code from the set of the randomized virtual addresses.

The address mapper is further configured to map the virtual address range to an instruction (or function) within the application code that is requesting the memory page. In an example, a user-space instruction pointer, also known as program counter, is used to obtain the instruction or function requesting the memory page. After obtaining the instruction, the memory address of the instruction is determined. Thereafter, the normalized address for the instruction is determined by calculating a difference/offset from the memory address of the instruction (instruction requesting the memory) to the starting memory address of the application code. An exemplary allocation of the application code in a virtual address space is further illustrated in FIG. 2b. In the example, the memory address of the instruction is 105, the starting memory address of the application code is 100.

Normalized address=memory address of instruction−starting address of the application code;

Thus, the normalized address=105−100, which equals 5.

Referring back to FIG. 2a, the statistics collector 204 is configured to obtain the memory usage pattern information. The memory usage pattern information for each one of the plurality of memory pages associated with the application may comprise a write intensity indication, a read intensity indication, an access frequency indication, and an access bandwidth indication. In an example, the write intensity indication, read intensity indication, an access frequency indication, and an access bandwidth indication could be represented by one of a label, a numerical value, or a range of values, or a combination thereof. For example, the label or numerical value may be represented by parameters including ‘low’, ‘medium’, ‘high’, and ‘none’. In another example, the numerical value may be represented by ‘X write requests per unit of time’, ‘between X and Y write requests per unit of time’, or ‘Y requests per unit of time’.

Based on the memory usage pattern information received from the statistics collector 204, the categorizer 206 is configured to map each normalized address determined with corresponding memory usage pattern information. The categorizer 206 is configured to categorize each normalized address with a page characteristic based on the memory usage pattern information. The page characteristics are indication generally defining the nature of the memory page, for example, indications such as frequently accessed page, cold page, hot page, read-only page, write-only page, and the like. The page characteristics may include other information or metrics corresponding to the randomized virtual address.

In an embodiment, if the categorizer 206 cannot classify (or group) a memory page effectively under a specific category, then the memory page is categorized under a ‘generic category’ based on the memory usage pattern information. In an embodiment, the categorizer 206 may update memory pages under ‘generic category’ in subsequent runs. The categorizer 206 is further configured to communicate the memory profile with the memory profile module 208. The memory profile module 208 is configured to store the memory profile containing the memory usage pattern information, the set of normalized addresses, and corresponding page characteristics. The memory profile module 208 may be a database communicating with other servers, network nodes and/or client applications. The memory profile module 208 is further configured to transmit the memory profile to the controller 102, post the termination of the application.

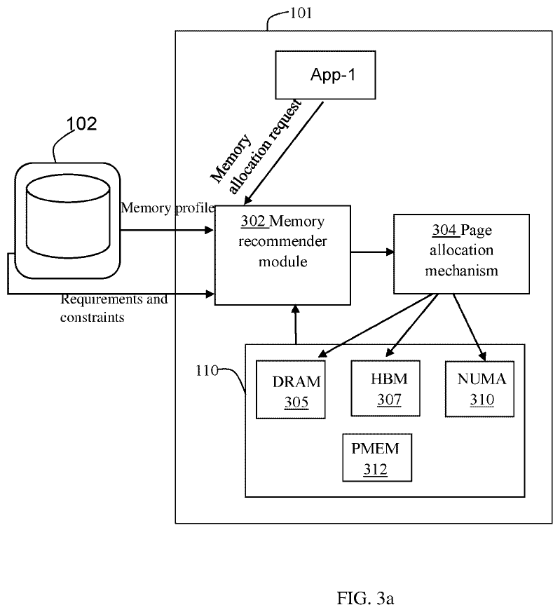

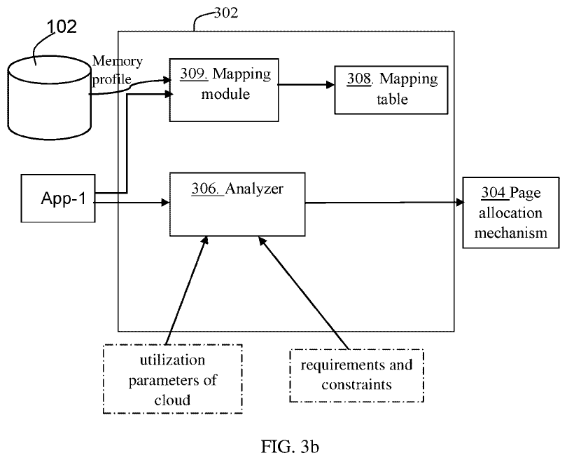

FIG. 3a shows a system according to some embodiments. The system 101 may be used during subsequent runs of the application after obtaining the memory profile (received from an initial test run of the application) corresponding to the application. The system 101 comprises a memory recommender module 302, the page allocation mechanism 304, and the heterogeneous memory 110. The heterogeneous memory 110 is a combination of diverse memories which may include DRAM, PMEM, HBM, Remote Memory, disaggregated memory, and the like. The system 101 could be implemented in a computing system, or in a single physical entity or a network node or may be distributed in a local network or in a cloud. The system 101 is configured to receive the memory profile corresponding to an application of interest (App-1) from the controller 102. The system 101 also receives requirements and constraints from the controller 102. Some examples of the requirements and constraints incudes a maximum memory available for the application (hard limit), a maximum amount to be kept in DRAM (soft limit), a memory bandwidth suggestion, a priority of the application, and the like.

The memory recommender module 302 is configured to determine at least one suitable memory type for allocation to at least one memory page associated with the application. The determination is performed based on the memory profile obtained. The determination is also based on the utilization parameters corresponding to a processing environment. The processing environment may be the system 101, or an external cloud server that executes the application. The utilization parameters include types of heterogeneous memory, current memory utilization, availability of memories. The determination of the suitable memory type is also performed based on requirements and constraints associated with the processing environment, for example requirements received from a cloud operator. The determination of at least one suitable memory type may be performed by one of a rule-based classification method or a machine learning algorithm.

Based on the recommendation received from the memory recommender module 302, the page allocation mechanism 304 is configured to allocate memory pages from determined memory type to the application or parts of the application. In an embodiment, the recommendation provided by the memory recommender module 302 is used for initial placement of pages associated with the application and the page allocation may be updated during subsequent runs of the application.

In some embodiment, the page allocation mechanism 304 is configured to allocate memory pages associated with the application to at least one suitable memory type in real-time. In some embodiment, the page allocation mechanism 304 is configured to allocate at least one suitable memory type after receiving a memory allocation request from the application. In another embodiment, the page allocation mechanism 304 is configured to assign at least one suitable memory type to each memory page associated with the application before receiving a memory allocation request from the application.

FIG. 3b shows an exemplary implementation of the memory recommender module 302, according to some embodiments. According to some embodiments, the memory recommender module 302 may be utilized in subsequent runs of the application after determining memory profile in an initial test run by the profiler module 108. The profiler module 108 is configured to receive the monitoring request from the controller 102, where the monitoring request corresponds to determining the memory profile for the App-1 (104) (as described in FIG. 2a). In response to the monitoring request, the profiler module 108 is configured to monitor the App-1 104 to record memory usage pattern information and thereby determine the memory profile. Thereafter, the profiler module 108 is configured to communicate the memory profile containing the memory usage pattern information, the set of normalized addresses, and corresponding page characteristics to the controller 102. The controller 102 sends the memory profile to a mapping module 309 present in the memory recommender module 302. The mapping module 309 is configured to obtain a set of current randomized virtual addresses used by various parts of the application in the subsequent runs. The mapping module 309 is further configured to map the set of current randomized virtual addresses with each normalized address from the set of normalized addresses received from the controller 102. Subsequently, the mapping module 309 is configured to map each normalized address determined with the memory usage pattern information present in the memory profile. The memory usage pattern information for each one of the plurality of memory pages associated with the application may comprise a write intensity indication, a read intensity indication, an access frequency indication, and an access bandwidth indication. Based on the memory usage pattern information, each of the normalized addresses is categorized with a page characteristic, such as frequently accessed page, cold page, hot page, read-only page, write-only page, and the like. The page characteristics could include other information or metrics corresponding to the randomized virtual address. Thereafter, the mapping module 309 is configured to communicate the set of current randomized virtual addresses with corresponding set of normalized addresses, and corresponding page characteristics to a mapping table 308. An exemplary arrangement of mapping table 308 is shown in Table 1 below:

TABLE 1

| Normalized | Virtual | Page |
|---|---|---|
| address range | address range | Characteristics |
| 0 × 40 to 0 × 140 | 0 × 03cb00 to 0 × 03cc00 | Read-intensive |
| 0 × 280 to 0 × 300 | 0 × 07ec00 to 0 × 7ed00 to | Write-intensive + |
| | 0 × 7ed00 | frequently accessed |
| 0 × 500 to 0 × 800 | 0 × 0fcb00 to 0 × ffc00 | Cold page |

The mapping table 308 is configured to provide information to an analyzer 306 present in the memory recommender module 302. The analyzer 306 is configured to receive a memory allocation request from the application. The analyzer 306 is configured to determine an instruction in the application requesting the memory. The analyzer 306 is configured to determine the base address of the application code and then calculate the normalized address. Based on the normalized address determined, the analyzer 306 is configured to lookup for the normalized address in the mapping table 308. If the normalized address of interest is found in the mapping table 308, the analyzer 306 retrieves the page characteristics associated with the normalized address or virtual address range. Thereafter, the analyzer 306 is configured to analyze and provide suitable memory type recommendations to the page allocation mechanism 304 about an initial placement of memory pages onto their corresponding heterogeneous memories available on the node based on parameters below:
a) Memory profile from initial test runs;
b) Utilization parameters corresponding to a processing environment include types of heterogeneous memory, current memory utilization, and availability of memories in the system 101;
c) Requirements and constraints associated with the processing environment such as a cloud server; and
d) Application current memory utilization and memory access statistics.

According to an embodiment herein, the analyzer 306 is configured to provide the suitable memory type recommendation using a rule-based classification. The rule-based classification may be implemented by using the memory profile information to classify pages associated with the normalized address into various groups. An example of classifying into different groups is given in Table 2 below:

TABLE 2

| | |
|---|---|
| Group 1 | Write-intensive pages |
| Group 2 | Read-intensive pages |
| Group 3 | Low read-intensive pages |
| Group 4 | Other pages which cannot be classified |

Thereafter, on subsequent runs, the analyzer 306 may be configured with rules that would classify pages into different groups, as given in an example below:
high_priority_applications:
   All pages: Allocate them to DRAM, if not available then on to HBM
   Soft Constraint: Try avoiding PMEM, unless no other option is available
medium_priority_applications:
   Group-1: Allocate on DRAM.
   Group-2: Allocate on DRAM, if not available then on to PMEM.
   Group-{3,4}: Always allocate on PMEM
Fallback: Defaults to DRAM in case of no other heterogeneous memory available in the node
Hard Constraint: Never use HBM
best_effort_applications:
   Group-1: Allocate on DRAM, else on to PMEM
   Group-{2,3,4}: Always allocate on PMEM
   Fallback: Defaults to DRAM in case of no other heterogeneous memory available in the node
   Hard Constraint: Never use HBM

According to an exemplary embodiment, any medium priority application is instantiated on a node with sufficient DRAM, PMEM, HBM during an initial test run. Now, when the medium priority application requests for memory in subsequent runs, the analyzer 306 would allocate the newly allocated virtual addresses that could span across different groups on the appropriate memories, for example, Group—{1,2} is allocated to DRAM, Group—{3,4} is allocated to PMEM. In this scenario, no group is allocated to HBM due to Hard Constraint rule that is defined. In another scenario, if the medium priority application is instantiated on a node, which has limited DRAM and comparatively higher PMEM, then the analyzer would allocate Group—{1} to DRAM, and all the remaining Groups—{2,3,4} would be placed on PMEM.

According to an embodiment herein, the analyzer 306 is configured to provide the suitable memory type recommendation using statistical models and machine learning techniques. Examples of machine learning techniques include Regression, Classification, Clustering, Neural Nets and Deep Learning, Transfer Learning, and Reinforcement Learning.

Referring to FIG. 3b, the recommendation generated by the analyzer 306 is communicated to the page allocation mechanism 304. The page allocation mechanism 304 is configured to perform real-time allocation of at least one suitable memory type received in the recommendation. In another embodiment, the page allocation mechanism 304 is configured to allocate at least one suitable memory type after receiving a memory allocation request from the application. In another embodiment, the page allocation mechanism 304 is configured to assign at least one suitable memory type before receiving a memory allocation request from the application. In the aforesaid scenario, the memory allocation is done post receiving the request from the application.

According to an embodiment herein, the recommendations generated by the analyzer 306 may also be stored in a Page Table Entry (PTE) (page table entry holds mapping between a virtual address of a page and the address of a physical memory) to minimize time spent in lookup to analyze and map normalized address. In another embodiment, the analyzer 306 is configured to generate a page fault if the normalized address is not mapped to a physical page during lookup.

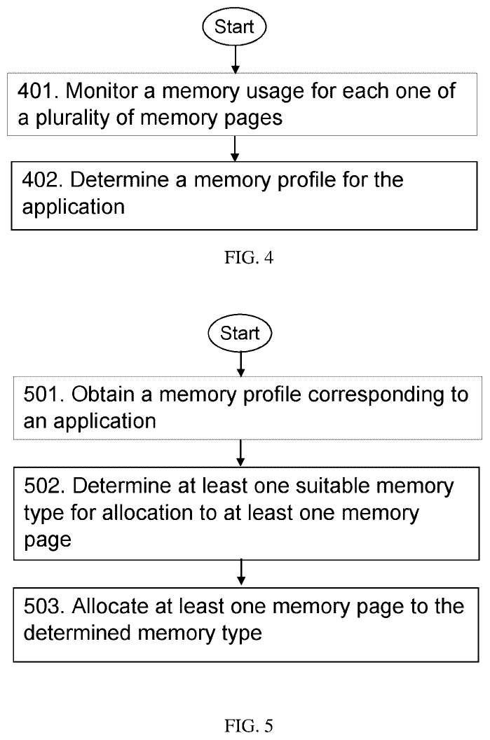

Embodiments of methods, performed by the system 100 or 101, will now be described with reference to flowcharts depicted in FIGS. 4 and 5. The methods may be understood to be for improved memory allocation in heterogeneous environment FIG. 4 shows a process according to some embodiments.

The method may comprise the actions described below. In some embodiments some of the actions may be performed. In some embodiments all the actions may be performed. One or more embodiments may be combined, where applicable. All possible combinations are not described to simplify the description.

Step 401 comprises monitoring a memory usage for each one of a plurality of memory pages associated with an application.

Step 402 comprises determining a memory profile for the application based on the monitoring. The memory profile may include memory usage pattern information for each one of the plurality of memory pages associated with the application.

In some embodiments, the memory usage pattern information for each one of the plurality of memory pages associated with the application comprises a write intensity indication, a read intensity indication, an access frequency indication, and an access bandwidth indication. Herein, the write intensity indication, the read intensity indication, the access frequency indication, and the access bandwidth indication may be represented by at least one of a label, a numerical value, and a range of values.

In some embodiments, the memory profile may include the memory usage pattern information, the set of normalized addresses, and corresponding page characteristics.

In some embodiments, the memory profile is determined during one or more test runs of the application. In some embodiments, the method comprises updating the memory profile during subsequent executions of the application.

In some embodiments, the method comprises storing the memory profile with the corresponding randomized virtual address range, determined normalized address range, and corresponding memory usage pattern information in a mapping table.

FIG. 5 shows a process performed according to some embodiments. The process may be performed by a computing system (e.g., system 101) to determine a suitable memory type for allocation to memory pages associated with the application based on the memory profile obtained from step 402. The process may begin with step 501.

Step 501 comprises obtaining a memory profile corresponding to an application.

Step 502 comprises determining at least one suitable memory type for allocation to at least one memory page associated with the application based on the memory profile obtained.

Step 503 comprises allocating the at least one memory page to the determined memory type.

In some embodiments, the step of determining at least one suitable memory type is further based on at least one of: a) utilization parameters corresponding to a processing environment; and b) requirements and constraints associated with the processing environment. The utilization parameters may include types of heterogeneous memory, current memory utilization, and availability of memories. The requirements and constraints may include, but are not limited to, maximum memory for the application (hard limit), maximum number of pages to be kept in DRAM (soft limit), memory bandwidth suggestion, and a priority of the application.

In some embodiments, the step of determining comprises associating a primary memory type for each one of the plurality of memory pages associated with the application from a plurality of memory types based on the determined memory profile, utilization parameters corresponding to the processing environment, and requirements and constraints associated with the processing environment.

In some embodiments, the determination of at least one suitable memory type is performed by one of a rule-based classification method or a machine learning algorithm.

In some embodiments, the method further comprises allocating at least one suitable memory type from the plurality of memory types to a memory page associated with the application. In some other embodiments, allocating at least one suitable memory type comprises mapping a virtual address assigned to the application to the suitable memory type. In some embodiments, allocating at least one suitable memory type is performed in real-time. In some embodiments, allocating at least one suitable memory type is performed after receiving a memory allocation request from the application. In some embodiments, the method comprises assigning at least one suitable memory type before receiving a memory allocation request from the application. The plurality of memory types may comprise Dynamic Random-Access Memory (DRAM), Remote Memory, Persistent memories with varying characteristics (PMEM), High Bandwidth Memory (HBM), On Chip or memories attached to the CPU through silicon via's or other interconnects, and disaggregated memory.

In some embodiments, the memory profile comprises the memory usage pattern information, the set of normalized addresses, and corresponding page characteristics.

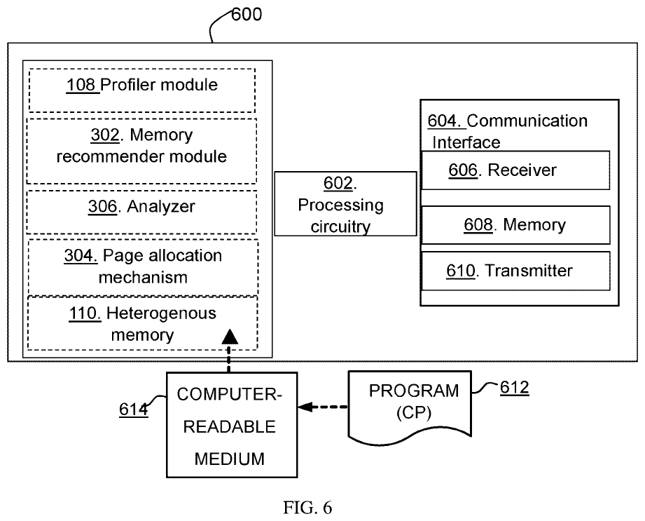

FIG. 6 is a block diagram of an apparatus 600, according to some embodiments, for performing the methods described above. As shown in FIG. 6, apparatus 600 may comprise: processing circuitry (PC) 602, which may include one or more processors (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed; a communication interface 604 optionally comprising a transmitter (Tx) 610 and a receiver (Rx) 606 for enabling apparatus 600 to transmit data to and receive data from processing circuitry 602 and other nodes or servers.

The apparatus 600 further includes a computer readable medium (CRM) 614 storing a computer program (CP) 612 comprising computer readable instructions (not shown). CRM 614 may be a non-transitory computer readable medium, such as, magnetic media (e.g., a hard disk), optical media, memory devices (e.g., random access memory, flash memory), and the like. In some embodiments, the computer readable instructions of computer program 612 is configured such that when executed by PC 602, the instructions cause apparatus 600 to perform steps described herein (e.g., steps described herein with reference to the flow charts). In other embodiments, apparatus 600 may be configured to perform steps described herein without the need for code. That is, for example, PC 602 may consist merely of one or more ASICs. Hence, the features of the embodiments described herein may be implemented in hardware and/or software.

The apparatus 600 may be configured to receive memory requests by an application and later determine a suitable memory type for allocation to memory pages associated with the application based on a determined memory profile by communicating with the memory recommender module 304, and analyzer 306. The apparatus 600 is configured to determine the memory profile by means of the profiler module 108. The apparatus 600 is configured to allocate suitable memory types from a plurality of memories present in the heterogeneous memory 110 by means of the page allocation mechanism 304. The embodiments described herein enables intelligent and automated allocation of memory pages at appropriate memory types.

The embodiments herein provide the following advantages:

Allocating memory pages onto an appropriate memory when the application requests for memory would help in avoiding the migration of a large number of pages between the memories during the runtime and thus helps in maintaining application performance. Avoiding or at least reducing migration of pages would also contribute to reducing additional resource consumption (CPU, energy and the like).

Proactive allocation of memory pages to the most appropriate memory (allocating memory pages onto an appropriate memory in the heterogeneous environment when the application requests for memory) may provide low memory access delay, low write power consumption, and high endurance of the DRAM.

There are no modifications required to the applications to use other heterogeneous memories. Application is transparent about where the memory pages are going to reside, i.e., in which heterogeneous memory.

May help improve utilization of specific performance-limited memories.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes and message flows described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a computing system, the method comprising:
monitoring a memory usage for each one of a plurality of memory pages associated with an application; and
based on the monitoring, determining a memory profile for the application, the memory profile comprising memory usage pattern information for each one of the plurality of memory pages associated with the application.

2. The method as claimed in claim 1, wherein the memory usage pattern information for each one of the plurality of memory pages associated with the application comprises a write intensity indication, a read intensity indication, an access frequency indication, and an access bandwidth indication.

3. The method as claimed in claim 2, wherein the write intensity indication, the read intensity indication, the access frequency indication, and the access bandwidth indication are represented by at least one of a label, a numerical value and a range of values.

4. The method as claimed in claim 1, wherein monitoring the memory usage comprises:
identifying a plurality of memory pages associated with the application based on a set of normalized addresses.

5. The method as claimed in claim 4, wherein the set of normalized address is determined based on a set of randomized virtual addresses used by various parts of the application.

6. The method as claimed in claim 4, wherein monitoring the memory usage comprises:
obtaining a memory usage pattern information for each normalized address.

7. The method as claimed in claim 4, wherein monitoring the memory usage comprises: categorizing each of the normalized addresses to a page characteristic based on the memory usage pattern information.

8. The method as claimed in claim 1, wherein the memory profile comprises one or more of: the memory usage pattern information, a set of normalized addresses, and corresponding page characteristics.

9. The method as claimed in claim 1, wherein the memory profile is determined during one or more test runs of the application.

10. The method as claimed in claim 1, wherein the memory profile is updated during subsequent runs of the application.

11. The method as claimed in claim 1, wherein the memory profile with the corresponding randomized virtual address range, determined normalized address range, and corresponding memory usage pattern information are stored in a mapping table.

12. A method performed by a computing system, wherein the computing system comprises a plurality of memory types, the method comprising:
obtaining a memory profile corresponding to an application;
determining at least one suitable memory type for allocation to at least one memory page associated with the application based on the memory profile obtained; and
allocating the at least one memory page to the determined memory type.

13. The method as claimed in claim 12, wherein determining at least one suitable memory type is further based on at least one of:
a) utilization parameters corresponding to a processing environment; and
b) requirements and constraints associated with the processing environment.

14. The method as claimed in claim 13, wherein determining comprises: for each one of the plurality of memory pages associated with the application, associating the suitable memory type from the plurality of memory types based on the determined memory profile, utilization parameters corresponding to the processing environment, and requirements and constraints associated with the processing environment.

15. The method as claimed in claim 12, wherein the determination of at least one suitable memory type is performed by one of a rule-based classification method or a machine learning algorithm.

16. The method as claimed in claim 12, wherein allocating at least one suitable memory type comprises mapping a virtual address assigned to the application to the suitable memory type.

17. The method as claimed in claim 12, wherein allocating at least one suitable memory type is performed in real-time.

18. The method as claimed in claim 12, wherein allocating at least one suitable memory type is performed after receiving a memory allocation request from the application.

19. The method as claimed in claim 12, wherein assigning at least one suitable memory type is performed before receiving a memory allocation request from the application.

20. The method as claimed in claim 12, wherein the plurality of memory types comprises at least one of: Dynamic Random-Access Memory (DRAM), Remote Memory, Persistent Memory (PMEM), High Bandwidth Memory (HBM), and Disaggregated memory.

21-25. (canceled)
